(19) United States
(12) Patent Application Publication
(10) Pub. No.: US 2009/0135707 A1
(43) Pub. Date: May 28, 2009

(54) INFORMATION RECORDING DEVICE AND METHOD, COMPUTER PROGRAM AND INFORMATION RECORDING MEDIUM

(75) Inventors: Tsuyoshi Namiki, Saitama (JP); Tsuyoshi Hasebe, Saitama (JP); Shinji Suzuki, Saitama (JP); Masayoshi Yoshida, Saitama (JP)

Correspondence Address: YOUNG & THOMPSON, 209 Madison Street, Suite 500, ALEXANDRIA, VA, 22314, US

(73) Assignee: PIONEER CORPORATION, Tokorozawa-shi (JP)

(21) Appl. No.: 12/090,943

(22) PCT Filed: Oct. 20, 2006
(86) PCT No.: PCT/JP2006/320922

§ 371 Date: Jul. 21, 2008

(30) Foreign Application Priority Data
Oct. 20, 2005 (JP) 2005-305921

(51) Int. Cl. G11B 7/24

(52) U.S. Cl. 369/275.3

(57) ABSTRACT

An information recording/reproducing device (300) is provided with (i) a recording element (302 or the like) for recording information at least in a second recording layer by laser beams passed through a first recording layer; (ii) a record control element (305 or the like) for controlling a recording element to record the recording information, by a recording unit of a recording area which includes a first area in the first recording layer and a second area in the second recording layer at a position facing the first area; and (iii) a format control element (305 or the like) for controlling the recording element to record the prescribed recording information in a first inner circumference area (FS0) and a second inner circumference area (FS1) wherein reproduction control information (File System) for controlling reproduction of the recorded information is to be recorded.

### TECHNICAL FIELD

The present invention relates to an information recording apparatus and method for an information recording medium, such as an optical disc on which recording and reproduction can be performed by irradiating it with laser light, such as a DVD (Digital Versatile Disc) and a CD (Compact Disc), a computer program, and the information recording medium.

### BACKGROUND ART

In a recording type information recording medium, such as a CD-R (Compact Disc-Recordable), a DVD-R, a DVD-RW, and a DVD+R, for example, as described in patent documents 1 and 2 or the like, there is also developed an information recording medium, such as a multilayer type or dual layer type optical disc, in which a plurality of recording layers are laminated or pasted on the same substrate. Then, on an information recording apparatus, such as a DVD recorder, for performing the recording with respect to the dual layer type, i.e., two-layer type, optical disc, laser light for recording is focused or condensed on a recording layer located on the front (i.e. on the closer side to an optical pickup) as viewed from the irradiation side of the laser light (hereinafter referred to as an “L0 layer”, as occasion demands) to thereby record information into the L0 layer in an irreversible change recording method by heat or a rewritable method. Moreover, the laser light is focused or condensed on a recording layer located on the rear of the L0 layer (i.e. on the farther side from the optical pickup) as viewed from the irradiation side of the laser light (hereinafter referred to as an “L1 layer”, as occasion demands), through the L0 layer or the like, to thereby record information into the L1 layer.

In particular, in a multilayer rewritable type information recording medium, such as a DVD-RW DL (Dual Layer), the following recording method can be considered. That is, there are suggested a recording method which applies both (i) a layer jump recording mode (hereinafter referred to as a “LJR mode” as occasion demands), which is employed in a multilayer write-once type information recording medium, such as a DVD-R DL (Dual Layer), and (ii) a restricted over write mode (hereinafter referred to as a “ROW mode” as occasion demands). Now the “LJR mode” in the present invention is a recording mode for recording record information by a recording unit of a recording area, including a first area in a recording area in the L0 layer and a second area in a recording area in the L1 layer facing the first area. Moreover the “ROW mode” in the present invention is a recording mode, which is generally performed on the rewritable type information recording medium and which allows random write, including additional recording (e.g., write-once recording) and rewriting, in the recording area in which the record information is recorded. The “random write” in the present invention means a recording process in which a user records arbitrary data at an arbitrary position in a recording layer in arbitrary timing.

When information is recorded into the L1 layer, which constitutes such a dual-layer type optical disc, the optimum recording power of the laser light with which the L1 layer is irradiated through the recorded L0 layer, as shown in FIG. 16(a), is 44.5 (mW: milliwatt) at which a jitter value is minimal on a parabolic curve in a thin line (with white triangles) in FIG. 16(c), for example. On the other hand, the optimum recording power of the laser light with which the L1 layer is irradiated through the unrecorded L0 layer which has a different light transmittance from that of the recorded L0 layer, as shown in FIG. 16(b), is 46 (mW: milliwatt) at which a jitter value is minimal on a parabolic curve in a thick line (with black triangles) in FIG. 16(c), for example. Thus, there is a need to consider whether or not the L0 layer is recorded, in the case of the recording in the L1 layer. With respect to this, there is devised or invented a recording method in which a so-called recording order is satisfied, which is that the laser light for recording which has penetrated or transmitted the L0 layer in a recorded state is to be irradiated, for example. Specifically, after the L0 layer is in a recorded state, information is recorded into the L1 layer by using laser light which holds an optimum recording power corresponding to the recorded L0 layer. On the other hand, the L0 layer is kept in an unrecorded state, and information is recorded into the L1 layer by using laser light which holds an optimum recording power corresponding to the unrecorded L0 layer. Alternatively, it is judged whether or not an area in the L0 layer facing an area in the L1 layer in which information is scheduled to be recorded is already recorded, on the basis of management information, such as space bit map (SBM), and information is recorded into the L1 layer on the basis of the judgment. Here, the expression “facing or opposed” may mean a positional relationship in which one portion of a recording area in the first recording layer and one portion of a recording area in the second recording layer are opposed to and correspond to each other; namely, they exist at almost the same radial position. Moreover, the expression “facing or opposed” may mean a positional relationship considering an error, such as an eccentricity.
Patent document 1: Japanese Patent Application Laid Open NO. 2000-311346
Patent document 2: Japanese Patent Application Laid Open NO. 2001-23237

### DISCLOSURE OF INVENTION

### Subject to be Solved by the Invention

However, if both the LJR mode and the ROW mode described above are used together in the aforementioned multilayer rewritable type information recording medium, such as a DVD-RW DL (Dual Layer), there is the following technical problem.

That is, there is such a technical problem that it is hard to record the record information, with the aforementioned recording requirement satisfied, in one portion of a data area in the L1 layer (e.g., a blank area in the L1 layer), adjacent to a predetermined range of recording area located in an inner circumferential portion of the L1 layer (hereinafter referred to as a “second inner area”, as occasion demands) and facing a predetermined range of recording area located in the inner circumferential portion of the L0 layer (hereinafter referred to as a “first inner area”, as occasion demands), wherein reproduction control information for controlling the reproduction of the record information, such as a file system, is expected to be recorded.

More specifically, in the aforementioned first inner area and the aforementioned second inner area, because the reproduction control data, such as a file system, is expected to be recorded therein, they are reserved so as not to record the record information, such as contents. Thus, on the basis of the aforementioned LJR mode, firstly, the record information is recorded from the inner circumference to the outer circumference in one portion of the data area in the L0 layer (hereinafter referred to as a “first area” as occasion demands) adjacent to the aforementioned first inner area. Then, if the record information is recorded from the outer circumference to the inner circumference in one portion of the data area in the L1 layer (hereinafter referred to as a “second area” as occasion demands) adjacent to the aforementioned second inner area, the recording area (a so-called blank area) in which the recording process cannot be performed with the recording requirement satisfied is generated at the boundary of the second inner area and the second area, which is a technical problem.

In view of the aforementioned conventional problems, it is therefore an object of the present invention to provide an information recording apparatus and method, which allow more appropriate recording of the record information, with the recording requirement satisfied, with respect to an information recording medium with a plurality of recording layers, a computer program which makes a computer function as such an information recording apparatus, and the information recording medium.

### Means for Solving the Subject

### Information Recording Apparatus

Hereinafter, the information recording apparatus of the present invention will be discussed.

The above object of the present invention can be achieved by an information recording apparatus for performing recording onto an information recording medium provided with: at least (i) a first recording layer in which a first track is formed to record one portion of record information; and (ii) a second recording layer in which a second track is formed to record another portion of the record information, the information recording apparatus provided with: a recording device for recording the another portion of the record information into at least the second recording layer, by using laser light transmitted through the first recording layer; a recording control device for controlling the recording device to record the record information by a recording unit (i.e. zone) of a recording area including a first area in the first recording layer and a second area in the second recording layer located facing the first area; and a format control device for controlling the recording device to record predetermined record information (e.g., buffer data: zero) in at least a first inner area (e.g., FS0), from among the first inner area located in an inner circumferential portion of the first recording layer and a second inner area (e.g., FS1) facing the first inner area and located in an inner circumferential portion of the second recording layer, reproduction control information (e.g., file system) for controlling reproduction of the record information being expected to be recorded into the first inner area and the second inner area.

According to the information recording apparatus of the present invention, under the control of the recording control device, the record information is recorded by the recording device by the recording unit of the recording area including the first area in the first recording area and the second area in the second recording layer located facing the first area, on the basis of e.g. a layer jump mode. Here, the “recording unit” of the present invention may indicate a group of recording areas facing each other in the layer jump recording method, in other words, a group of the first area and the second area, i.e. zone.

In particular, according to the present invention, under the control of the format control device, the predetermined record information (e.g., buffer data: zero) is recorded by the recording device into at least the first inner area (e.g., FS0), from among (i) the first inner area (e.g., FS0) located in the inner circumferential portion of the first recording layer and (ii) the second inner area (e.g., FS1) facing the first inner area and located in the inner circumferential portion of the second recording layer, wherein the reproduction control information (e.g., file system) for controlling reproduction of the record information is expected to be recorded into the first inner area or the second inner area. Here, the “predetermined record information” of the present invention may indicate, for example, buffer data and the record information that makes the recording area substantially equivalent to in a recorded state, such as “zero” and “Null”. Incidentally, the predetermined record information may be recorded in predetermined timing, such as in the manufacturing of an optical disc or in the background format in parallel with a recording operation.

As a result, it is possible to almost or completely eliminate the recording of the record information by the information recording apparatus without the recording requirement satisfied, in one portion of the data area in the second recording layer (e.g., a blank area in the L1 layer described later) adjacent to the second inner area. Consequently, it is possible to record the record information, more appropriately, with the recording requirement satisfied, with respect to all the recording areas on the rewritable type information recording medium with a plurality of recording layers, such as a DVD-RW DL.

In one aspect of the information recording apparatus of the present invention, the format control device controls the recording device to record the predetermined record information in the first inner area.

According to this aspect, it is possible to realize the recording process for the predetermined record information, which is recorded in predetermined timing, such as in the manufacturing of an optical disc or in the background format in parallel with the recording operation, more quickly and accurately than the case the recording process is performed in the first inner area and the second area.

In another aspect of the information recording apparatus of the present invention, the format control device controls the recording device to record the predetermined record information in (i) the entire first inner area and (ii) in an outer circumferential edge portion of the second inner area.

According to this aspect, it is possible to almost or completely eliminate the recording of the record information by the information recording apparatus without the aforementioned recording requirement satisfied, in one portion of the data area in the second recording layer (e.g., a blank area in the L1 layer described later) adjacent to the second inner area, And it is possible to realize the recording process for the predetermined record information, more quickly and accurately.

In another aspect of the information recording apparatus of the present invention, the format control device controls the recording device to record the predetermined record information in entire recording areas in the first recording layer and the second recording layer.

According to this aspect, it is possible to almost or completely eliminate the recording of the record information by the information recording apparatus without the aforementioned recording requirement satisfied, in the entire data area in the second recording layer including one portion of the data area in the second recording layer (e.g., a blank area in the L1 layer described later) adjacent to the second inner area.

In another aspect of the information recording apparatus of the present invention, the format control device controls the recording device to record the predetermined record information simultaneously with or in tandem with the recording of the record information.

According to this aspect, the predetermined record information can be recorded simultaneously with or in tandem with the recording of the record information. Here, the expression “simultaneously with or in tandem with the recording of the record information” may mean the recording in predetermined timing, such as in the background format in parallel with a recording operation, in addition to or instead of in the manufacturing of an optical disc. Alternatively, there may be a plurality of recording devices, such as optical pickups, and simultaneously with or in tandem with the recording of the record information by one recording device, the predetermined record information may be recorded by another recording device. It is possible to record the predetermined record information in appropriate response to the purpose and application of the information recording medium.

In another aspect of the information recording apparatus of the present invention, the information recording medium is provided with a management area (e.g., RMA) for recording management information (e.g., RMD) including one position information about an outer circumferential edge portion of the recording area in which the record information is in a recorded state, and the recording control device controls the recording device to record the management information into the management area.

According to this aspect, it is possible to perform the recording process based on a ROW mode, on the recording area in which the record information is recorded on the dual-layer rewritable type optical disc in the embodiment. That is, random write can be performed, including additional recording and rewritable recording, by the information recording apparatus with respect to the information recording medium.

In another aspect of the information recording apparatus of the present invention, the information recording medium is provided with a management area (e.g., RMA) for (i) managing the recording or reproduction of the record information and (ii) recording management information (e.g., RMD) including another position information about an outer circumferential edge portion in the first inner area and the second inner area, and the recording control device controls the recording device to record the management information into the management area.

According to this aspect, the predetermined record information can be recorded, continuously in time or discontinuously, in the first inner area and the partial or entire recording area of the second inner area, for example, by another information recording apparatus on the basis of the obtained management information.

In another aspect of the information recording apparatus of the present invention, the information recording medium is provided with a management area (e.g., RMA) for recording management information (e.g., RMD) including identification information (e.g., flag information) which indicates whether or not the predetermined record information is recorded on the information recording medium, and the recording control device controls the recording device to record the management information into the management area.

According to this aspect, it can be identified, quickly and accurately, whether or not it is necessary to record the predetermined record information, for example, by another information recording apparatus on the basis of the obtained management information.

In this aspect, the information recording apparatus may be provided with an obtaining device for obtaining the management information, the format control device may control the recording device to record the predetermined record information on the basis of the obtained management information, and the recording control device may control the recording device to record the record information on the basis of the obtained management information.

By virtue of such construction, under the control of the format control device based on the obtained management information, the recording device can record the predetermined record information, more appropriately. In addition, under the control of the recording control device based on the obtained management information, the recording device can record the record information, more appropriately.

(Information Recording Method)

Hereinafter, the information recording method of the present invention will be discussed.

The above object of the present invention can be also achieved by an information recording method in an information recording apparatus for performing recording onto an information recording medium provided with: at least (i) a first recording layer in which a first track is formed to record one portion of record information; and (ii) a second recording layer in which a second track corresponding to the first track is formed to record another portion of the record information, the information recording apparatus provided with: a recording device for recording the another portion of the record information into at least the second recording layer, by using laser light transmitted through the first recording layer, the information recording method provided with: a recording control process of controlling the recording device to record the record information by a recording unit of a recording area including a first area in the first recording layer and a second area in the second recording layer located facing the first area; and a format control process of controlling the recording device to record predetermined record information in at least a first inner area (e.g., FS0), from among the first inner area located in an inner circumferential portion of the first recording layer and a second inner area (e.g., FS1) facing the first inner area and located in an inner circumferential portion of the second recording layer, reproduction control information (e.g., file system) for controlling reproduction of the record information being expected to be recorded into the first inner area and the second inner area.

According to the information recording method of the present invention, it is possible to receive the various benefits of the aforementioned information recording apparatus of the present invention.

Incidentally, in response to the various aspects of the information recording apparatus of the present invention described above, the information recording method of the present invention can employ various aspects.

(Computer Program)

Hereinafter, the computer program of the present invention will be discussed.

The above object of the present invention can be also achieved by a computer program for recording control and for controlling a computer provided in the aforementioned information recording apparatus of the present invention (including its various aspects), the computer program making the computer function as at least one portion of the recording device, the recording control device, and the format control device.

According to the computer program of the present invention, the aforementioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned information recording apparatus of the present invention, the computer program of the present invention can adopt various aspects.

The above object of the present invention can be also achieved by a computer program product in a computer-readable medium for tangibly embodying a program of instructions executable by a computer provided in the aforementioned information recording apparatus of the present invention (including its various aspects), to make the computer function as at least one portion of the recording device, the recording control device, and the format control device.

According to the computer program product of the present invention, the aforementioned information recording apparatus can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus.

(Information Recording Medium)

Hereinafter, the information recording medium of the present invention will be discussed.

The above object of the present invention can be also achieved by an information recording medium provided with: at least (i) a first recording layer in which a first track is formed to record one portion of record information; and (ii) a second recording layer in which a second track corresponding to the first track is formed to record another portion of the record information, wherein predetermined record information (e.g., buffer data: zero) is recorded in advance in at least a first inner area (e.g., FS0), from among the first inner area located in an inner circumferential portion of the first recording layer and a second inner area (e.g., FS1) facing the first inner area and located in an inner circumferential portion of the second recording layer, reproduction control information (e.g., file system) for controlling reproduction of the record information being expected to be recorded into the first inner area and the second inner area.

According to the information recording medium of the present invention, the record information can be recorded by the recording unit of the recording area including the first area in the first recording area and the second area in the second recording layer located facing the first area, for example, by the aforementioned information recording apparatus, on the basis of e.g. a layer jump mode.

In particular, according to the present invention, the predetermined record information (e.g., buffer data: zero) is recorded in at least the first inner area (e.g., FS0), from among the first inner area (e.g., FS0) located in the inner circumferential portion of the first recording layer and (ii) the second inner area (e.g., FS1) facing the first inner area and located in the inner circumferential portion of the second recording layer, wherein the reproduction control information (e.g., file system) for controlling the reproduction of the record information is expected to be recorded into the first inner area and the second inner area. Incidentally, the predetermined record information may be recorded in predetermined timing, such as in the manufacturing of an optical disc.

As a result, it is possible to almost or completely eliminate the recording of the record information by the aforementioned information recording apparatus without the recording requirement satisfied, in one portion of the data area in the second recording layer (e.g., a blank area in the L1 layer described later) adjacent to the second inner area. Consequently, it is possible to record the record information, more appropriately, with the recording requirement satisfied, with respect to all the recording areas on the rewritable type information recording medium with a plurality of recording layers, such as a DVD-RW DL.

Incidentally, in response to the various aspects in the aforementioned information recording apparatus of the present invention, the information recording medium of the present invention can adopt various aspects.

In one aspect of the information recording medium of the present invention, it is provided with a management area (e.g., RMA) for recording management information (e.g., RMD) including one position information about an outer circumferential edge portion of the recording area in which the record information is in a recorded state.

According to this aspect, it is possible to perform the recording process based on the ROW mode, by the aforementioned information recording apparatus, on the recording area in which the record information is recorded on the dual-layer rewritable type optical disc in the embodiment. That is, random write can be performed, including additional recording and rewritable recording, by the information recording apparatus with respect to the information recording medium.

In another aspect of the information recording medium of the present invention, it is provided with a management area (e.g., RMA) for (i) managing the recording or reproduction of the record information and (ii) recording management information (e.g., RMD) including another position information about an outer circumferential edge portion in the first inner area and the second inner area.

According to this aspect, the predetermined record information can be recorded, continuously in time or discontinuously, in the partial or entire recording area of the first inner area and the second inner area, for example, by another information recording apparatus on the basis of the obtained management information.

In another aspect of the information recording medium of the present invention, it is provided with a management area for recording management information including identification information (e.g., flag information) which indicates whether or not predetermined record information is recorded on the information recording medium.

According to this aspect, it can be identified, quickly and accurately, whether or not it is necessary to record the predetermined record information, for example, by another information recording apparatus on the basis of the obtained management information.

These effects and other advantages of the present invention will become more apparent from the following embodiment.

As explained above, according to the information recording apparatus of the present invention, it is provided with the recording device, the recording control device, and the format control device. According to the information recording method of the present invention, it is provided with the recording process, the recording control process, and the format control process. As a result, it is possible to almost or completely eliminate the recording of the record information by the information recording apparatus without the recording requirement satisfied, in one portion of the data area in the second recording layer (a blank area in the L1 layer described later) adjacent to the second inner area.

Moreover, according to the computer program of the present invention, it makes a computer function as the aforementioned information recording apparatus of the present invention. Thus, it is possible to almost or completely eliminate the recording of the record information by the information recording apparatus without the recording requirement satisfied, in one portion of the data area in the second recording layer (a blank area in the L1 layer described later) adjacent to the second inner area.

Moreover, according to the information recording medium of the present invention, it is provided with the first recording layer and the second recording layer, and the predetermined record information is recorded in advance in the first inner area (e.g., FS0) and the second inner area (e.g., FS1). As a result, it is possible to almost or completely eliminate the recording of the record information by the information recording apparatus without the recording requirement satisfied, in one portion of the data area in the second recording layer (e.g., a blank area in the L1 layer described later) adjacent to the second inner area.

### BRIEF DESCRIPTION OF DRAWINGS

FIG. 1 are a substantial plan view showing the basic structure of an optical disc having a plurality of recording areas in an embodiment of an information recording medium of the present invention (FIG. 1(a)), and a schematic conceptual view showing a recording area structure in the radial direction corresponding to a cross sectional view of the optical disc (FIG. 1(b)).

FIG. 2 is one conceptual graph showing the data structure of a dual-layer type optical disc in the embodiment of the information recording medium of the present invention, a physical sector number which constitutes an ECC block in the recording area of the optical disc, and a recording or reproducing method in an opposite method of the optical disc.

FIG. 3 is another conceptual graph showing the data structure of a dual-layer type optical disc in the embodiment of the information recording medium of the present invention, the physical sector number which constitutes the ECC block in the recording area of the optical disc, and the recording or reproducing method in the opposite method of the optical disc.

FIG. 4 is a conceptual schematic diagram showing a recording area in which format data is recorded on the dual-layer rewritable type optical disc in the embodiment of the information recording medium of the present invention.

FIG. 5 is a conceptual schematic diagram showing a recording area in which format data is recorded and in which a recording process is performed on the basis of a LJR mode, on the dual-layer rewritable type optical disc in the embodiment of the information recording medium of the present invention.

FIG. 6 is a table showing one specific example of the content of RMD associated with management information of the present invention.

FIG. 7 is a block diagram showing the basic structures of a host computer and an information recording/reproducing apparatus in an embodiment of the information recording apparatus of the present invention.

FIG. 8 is a flowchart showing a format process by the information recording/reproducing apparatus in the embodiment of the information recording apparatus of the present invention.

FIG. 9 are a conceptual schematic diagram showing a recording process based on a ROW mode on a single-layer rewritable type optical disc in a comparison example (FIG. 9(a)), and a conceptual schematic diagram showing a recording process based on the LJR mode on a dual-layer write-once type optical disc in a comparison example (FIG. 9(b)).

FIG. 10 is a conceptual schematic diagram showing a recording process based on the ROW mode and the LJR mode, on a dual-layer rewritable type in a comparison example.

FIG. 11 is a schematic diagram enlarging a partial physical structure of a data area in a L1 layer, in which it is hard to record the record information satisfying a recording requirement, on the dual-layer rewritable type in the comparison example.

FIG. 12 is a schematic diagram enlarging a partial physical structure of the data area in the L1 layer, in which it is possible to record the record information satisfying a recording requirement, on the dual-layer rewritable type in the embodiment of the information recording medium of the present invention.

FIG. 13 is a conceptual schematic diagram showing another specific example (part 1) of the recording area in which the format data is recorded on the dual-layer rewritable type optical disc in the embodiment of the information recording medium of the present invention.

FIG. 14 is a conceptual schematic diagram showing another specific example (part 2) of the recording area in which the format data is recorded on the dual-layer rewritable type optical disc in the embodiment of the information recording medium of the present invention.

FIG. 15 is a conceptual schematic diagram showing another specific example (part 3) of the recording area in which the format data is recorded on the dual-layer rewritable type optical disc in the embodiment of the information recording medium of the present invention.

FIG. 16 are schematic diagrams conceptually showing a recording order in the present invention (FIG. 16(a) and FIG. 16(b)) and a graph numerically showing the recording order (FIG. 16(c)).

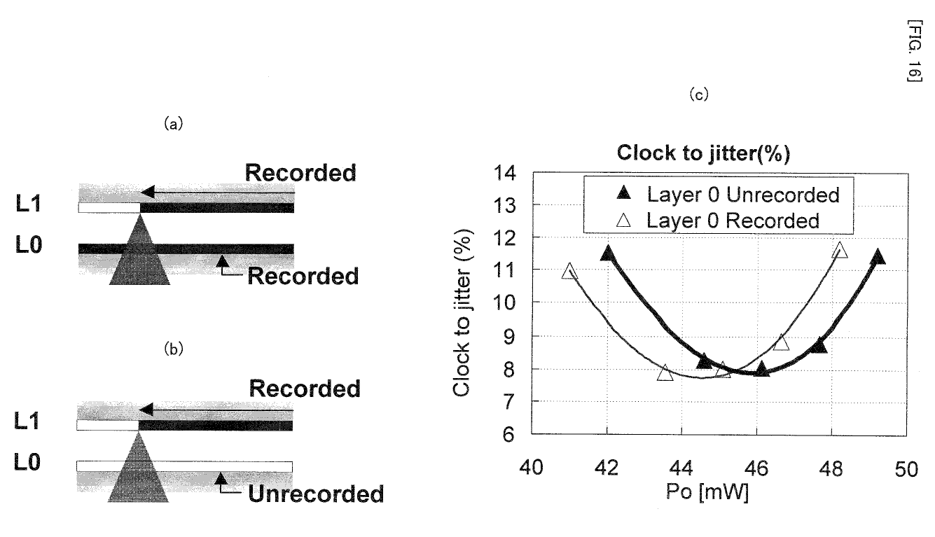

### DESCRIPTION OF REFERENCE CODES

1 . . . center hole, 10 . . . track, 11 . . . ECC block, 100 . . . optical disc, 101 . . . lead-in area, 102 . . . data area, 103 . . . lead-out area, 104 . . . middle area, 104s . . . shift middle area, 300 . . . information recording/reproducing apparatus, 301 . . . optical pickup, 302 . . . signal recording/reproducing device, 303 . . . address detection device, 305 . . . CPU (drive control device), 306 . . . spindle motor, 307 (402) . . . memory, 308 (406) . . . data input/output control device, 309 (407) . . . bus, 400 . . . host computer, 401 . . . CPU (for host), 403 . . . operation control device, 404 . . . operation button, 405 . . . display panel, CDZ . . . control data zone, RMA . . . recording management area, LB . . . laser light

### BEST MODE FOR CARRYING OUT THE INVENTION

Hereinafter, the best mode for carrying out the present invention will be discussed in order for each embodiment, with reference to the drawings.

### (1) Embodiment of Information Recording Medium

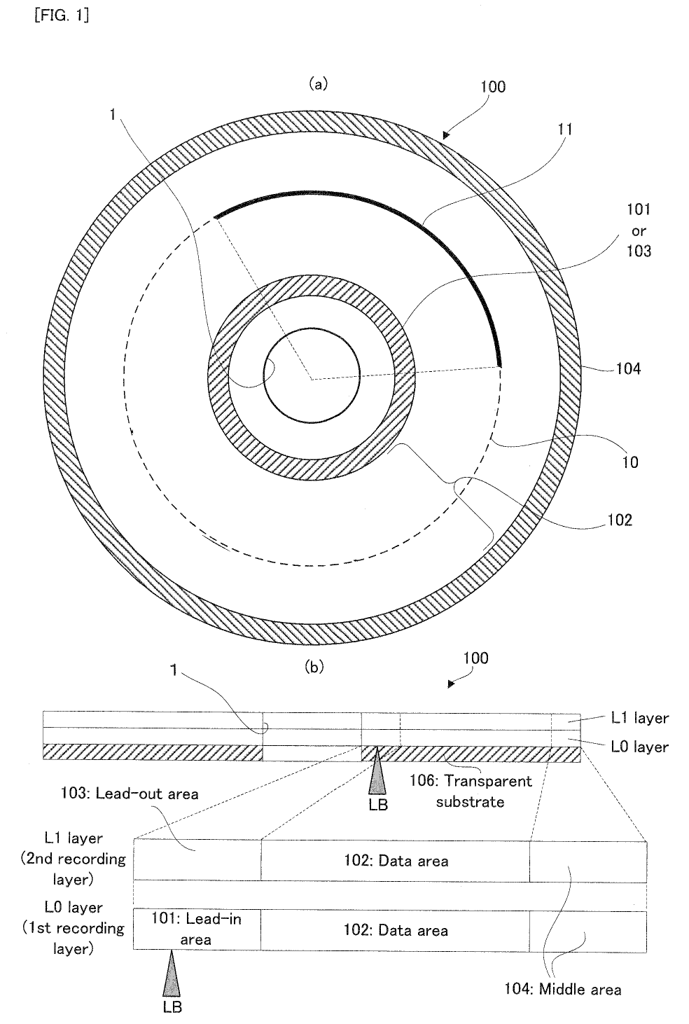

Next, with reference to FIG. 1 to FIG. 6, a detailed explanation will be given on an embodiment of the information recording medium of the present invention.

(1-1) Basic Structure

Firstly, with reference to FIG. 1, the basic structure of an optical disc in the embodiment of the recording medium of the present invention will be discussed. FIG. 1 are a substantial plan view showing the basic structure of an optical disc having a plurality of recording areas in an embodiment of an information recording medium of the present invention (FIG. 1(a)), and a schematic conceptual view showing a recording area structure in the radial direction corresponding to a cross sectional view of the optical disc (FIG. 1(b)). Incidentally, the optical disc in the embodiment employs an opposite method in which a track path in the L0 layer and a track path in the L1 layer have opposite recording directions, as one specific example of the recording manner.

As shown in FIG. 1(a) and FIG. 1(b), an optical disc 100 has a recording surface on a disc main body with a diameter of about 12 cm, as is a DVD. On the recording surface, the optical disc 100 is provided with: center hole 1 as the center; a lead-in area 101 or a lead-out area 103; a data area 102; and a middle area 104, which are associated with the embodiment. Then, for example, on a transparent substrate 106 of the optical disc 100, there are laminated recording layers, such as an L0 layer and an L1 layer. In each recording area of the recording layers, tracks 10, such as groove tracks and land tracks, are alternately placed, spirally or concentrically, centered on the center hole 1. On the track 10, data is divided and recorded by a unit of ECC block 11. The ECC block 11 is a data management unit by which record information is error-correctable.

Incidentally, the present invention is not particularly limited to the optical disc having these three areas. For example, even if the lead-in area 101, the lead-out area 103 or the middle area 104 does not exist, a data structure explained below can be constructed. Moreover, as described later, the lead-in area 101, the lead-out area 103 or the middle area 104 may be further segmentized.

The optical disc 100 in the embodiment, as shown in FIG. 1(b), has such a structure that the L0 layer and the L1 layer, which constitute one example of the “first and second record layers” of the present invention as descried later, respectively, are laminated on the transparent substrate 106. Upon the recording/reproduction of such a dual-layer type optical disc 100, the recording/reproduction in the L0 layer or the L1 layer is performed, depending on which recording layer has the focus position of laser light LB, irradiated from the lower to upper side in FIG. 1(b). Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers. Incidentally, a recording or reproduction procedure by the opposite method on the dual-layer type optical disc and a data structure in each layer will be described later.

(1-2) Detailed Structure

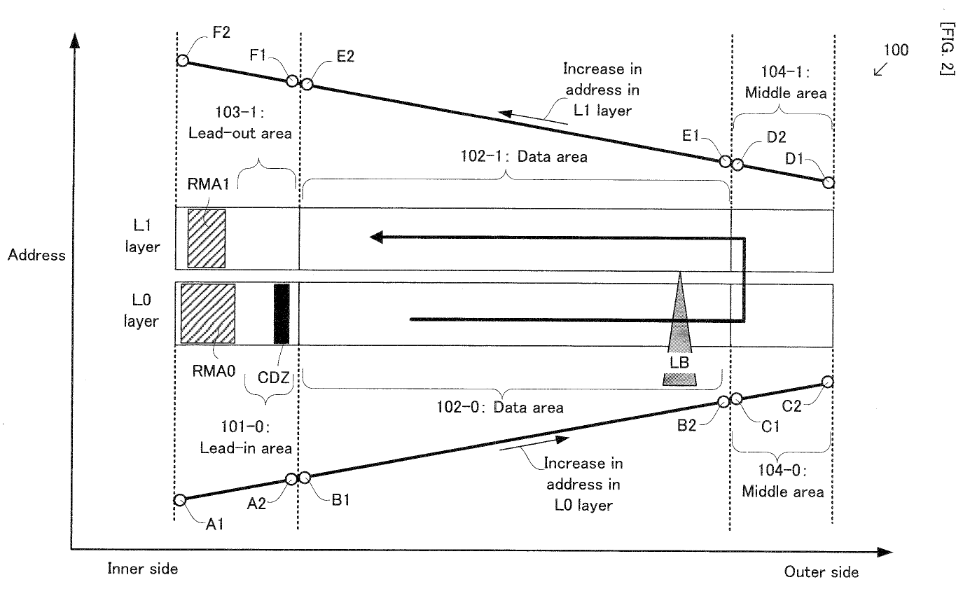

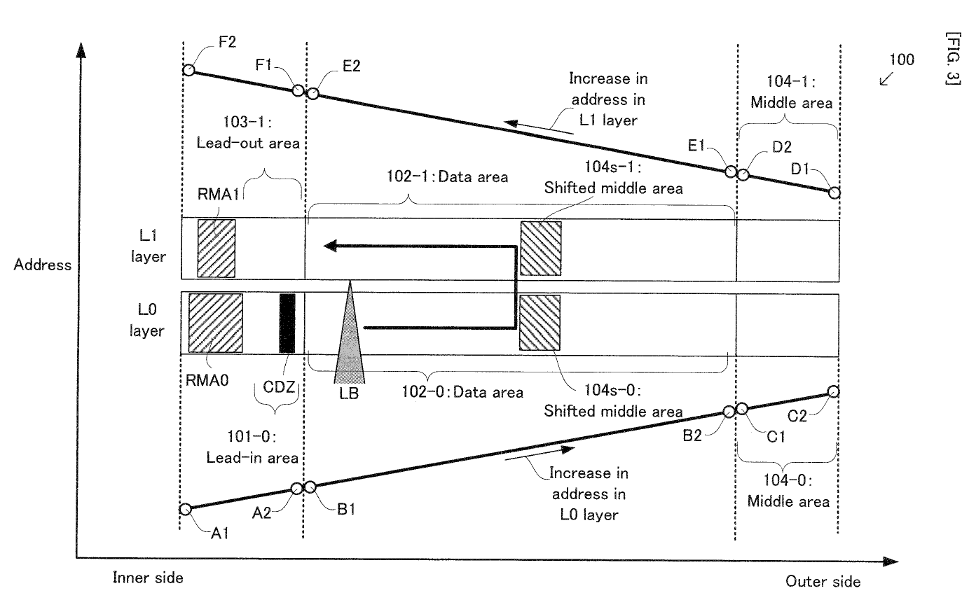

Next, with reference to FIG. 2 and FIG. 3, the detailed structure of the dual-layer type optical disc in the embodiment of the information recording medium of the present invention will be discussed. More specifically, with reference to FIG. 2 and FIG. 3, the data structure of the dual-layer type optical disc, a physical sector number which constitutes an ECC block in the recording area of the optical disc, and a recording or reproducing procedure in the opposite method of the optical disc will be discussed. FIG. 2 is one conceptual graph showing the data structure of the dual-layer type optical disc in the embodiment of the information recording medium, the physical sector number which constitutes the ECC block in the recording area of the optical disc, and the recording or reproducing method in an opposite method of the optical disc. FIG. 3 is another conceptual graph showing the data structure of a dual-layer type optical disc in the embodiment of the information recording medium of the present invention, the physical sector number which constitutes the ECC block in the recording area of the optical disc, and the recording or reproducing method in the opposite method of the optical disc. Incidentally, the vertical axis in FIG. 2 and FIG. 3 indicates the sector number expressed by hexadecimal numeral, and the horizontal axis indicates a relative position in the radial direction of the optical disc.

As shown in FIG. 2, the dual-layer type optical disc 100 in the embodiment of the information recording medium of the present invention is provided with two recording layers laminated on a not-illustrated substrate, i.e. the L0 layer and the L1 layer. Specifically, the L0 layer is provided, from the inner to the outer circumferential side, with: a recording management area RMA0; a lead-in area 101-0; a data area 102-0; and a middle area 104-0.

In the RMA0 (and RMA1 described later), it is possible to record RMD (Recording Management Data) which constitutes one example of the “management information” of the present invention. Specifically, in the RMA0 (RMA1), the RMD can be additionally recorded or written once, about 818 times. The RMA0 (RMA1) constitutes one example of the “management information recording area” of the present invention.

The lead-in area 101-0 is provided with a control data zone CDZ. In the control data zone CDZ, various information, such as the number of recording layers, the direction of the recording track, and a track pitch, is formed in advance by using embossed pits, or is pre-recorded with laser light or the like, for example. Moreover, in the data area 102-0, the record information can be recorded. Furthermore, the middle area 104-0 has a basic function to prevent a recording or reproduction position with respect to the L0 layer and the L1 layer from deviating to an unrecorded area and the outside of the substrate. It also has a function as a so-called” jump buffer area”, which is to prevent, in layer jump, the recording or production position from deviating to the unrecorded area and the outside of the substrate.

On the other hand, the L1 layer is provided, from the outer to the inner circumferential side, with: the middle area 104-1; a data area 102-1; a lead-out area 103-1; and a RMA1. More specifically, the RMA0 (RMA1) and a not-illustrated calibration area in which power calibration of laser light is performed may be collectively referred to as a “R-Information Area”. Moreover, the above-mentioned lead-in area 101-0 (101-1), the data area 102-0 (102-1), and the middle area 104-0 (104-1) may be collectively called as an “Information Area”.

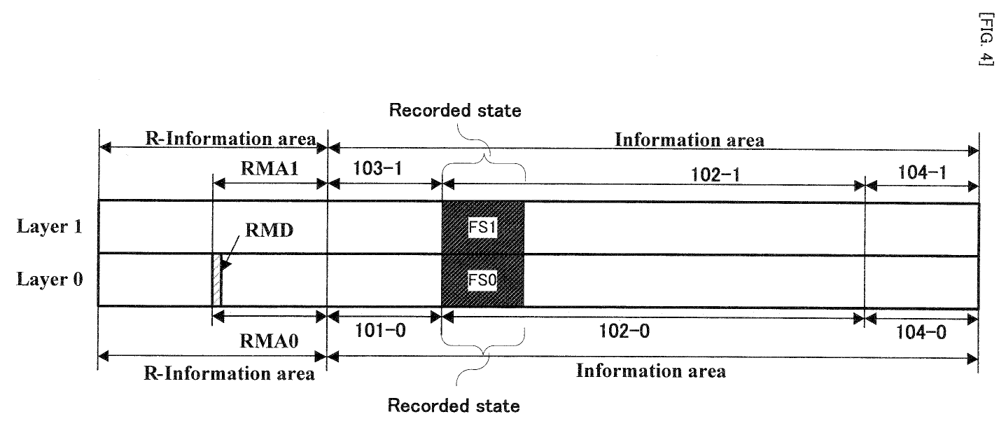

Moreover, in the optical disc 100 in the embodiment, the outer circumferential end of the data area 102-0 (102-1) may be located on the inner circumferential side if the data amount of the record information is relatively smaller than the entire recording capacity of the optical disc, in the incremental recording method or the like, for example, as shown in FIG. 4. In this case, in a direction to the outer circumferential side from the outer circumferential end of the data area 102-0 (102-1), there may be provided a shifted middle area 104s-0 (104s-1).

The dual-layer type optical disc 100 is constructed in the above manner, so that in the recording or reproduction of the optical disc 100, the laser light LB is irradiated from the side of a not-illustrated substrate, i.e., from the lower to the upper side in FIG. 2 and FIG. 3, by the optical pickup or the like of an information recording/reproducing apparatus in one specific example of the information recording apparatus of the present invention described later, and the focal distance thereof or the like is controlled. At the same time, the travel distance and direction in the radial direction of the optical disc 100 are controlled. By this, the data is recorded into each recording layer, or the recorded data is reproduced.

As the recording or reproduction procedure of the dual-layer type optical disc in the embodiment of the information recording medium of the present invention, the opposite method is employed. More specifically, the opposite method herein is such a method that the optical pickup of the information recording/reproducing apparatus described later is displaced from the inner to the outer circumferential side, i.e. in a direction of a right-pointing arrow in FIG. 2 and FIG. 3, in the L0 layer as the recording or reproducing procedure of the dual-layer type optical disc, while the optical pickup is displaced from the outer to the inner circumferential side, i.e. in a direction of a left-pointing arrow in FIG. 2 and FIG. 3, in the L1 layer, to thereby perform the recording or reproduction on the dual-layer type optical disc. In the opposite method, if the recording or reproduction is ended in the L0 layer, the optical pickup, located on the outermost circumference, does not need to be displaced again to the innermost circumference when the recording or reproduction is started in the L1 layer, and it is only necessary to change the focal distance from the L0 layer to the L1 layer. Thus, there is an advantage that a changing time from the L0 layer to the L1 layer is shorter than that in the parallel manner. This is why the opposite method is employed in the recording of large volumes of content information.

Specifically, as shown in the graph part of FIG. 2, firstly, in the L0 layer, as the optical pickup is displaced in the lead-in area 101-0, the data area 102-0, and the middle area 104-0, from the inner to the outer circumferential side, the sector number in the recording area of the optical disc 100 increases. More specifically, the optical pickup sequentially accesses an inner circumferential edge “A1”, an end position “A2” of the lead-in area 101-0, a start position “B1” of the data area 102-0, and an end position “B2” of the data area 102-0, and the optical pickup is displaced to the middle area 104-0 (whose start position is “C1” and whose end position is “C2”) which functions as the buffer, by which the recording or reproduction is performed in the L0 layer. Incidentally, in the embodiment, one specific example of the first track of the present invention is constructed by using a recording track defined by the linear line that indicates an increase in the address in the L0 layer. On the other hand, in the L1 layer, specifically, as the optical pickup is displaced in the middle area 104-1, the data area 102-1, and the lead-out area 103-1 from the outer to the inner circumferential side, the sector number in the recording area of the optical disc 100 increases. More specifically, the optical pickup sequentially accesses the middle area 104-1 (whose start position is “D1” and whose end position is “D2”) which functions as the buffer, a start position “E1” of the data area 102-1 and an end position “E2” of the data area 102-1, and the optical pickup is displaced to the lead-out area 103-1 (whose start position is “F1” and whose end position is “F2”), by which the recording or reproduction is performed in the L1 layer. Incidentally, one specific example of the second track of the present invention is constructed by using a recording track defined by the linear line that indicates a decrease in the address in the L1 layer.

All the addresses, such as the sector numbers, in the L0 layer and the L1 layer explained above may have a 15's complement number relationship in the hexadecimal numeral. More specifically, a turn-around point in the L0 layer (with a sector number of “1AFFFFh”) and a turn-around point in the L1 layer (with a sector number of “E50000h”) may have the 15's complement number relationship. Incidentally, in the embodiment, “h” which is the end of “30000h” or the like indicates that it is expressed by hexadecimal numeral. As a formal matter, the complement number of the “1AFFFFh” is obtained by converting the sector number of “1AFFFFh” in the hexadecimal numeral to a binary number of “000110101111111111111111”, inverting the bits to “111001010000000000000000”, and reconverting it to the “E50000h” in the hexadecimal numeral.

With respect to the physical sector number explained above, a Logical Block Address (LBA) may be assigned or allocated, one to one. More specifically, for example, a “000000” LBA corresponds to a sector number of “030000h”, and a “17FFFF” LBA corresponds to a sector number of “1AFFFFh”. Moreover, a “180000” LBA corresponds to a sector number of “E50000h”, and a “2FFFEF” LBA corresponds to a sector number of “FCFFEFh”. Thus, for example, a host computer can perform the recording and reproduction operations in accordance with the logical block address managed by a file system, for example, without regard to the physical sector number.

(1-3) One Specific Example of Method of Recording Format Data and Management Information

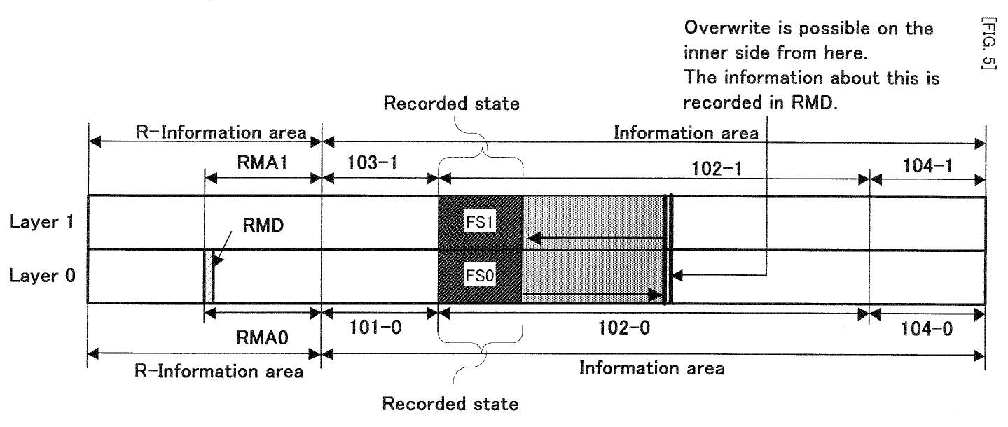

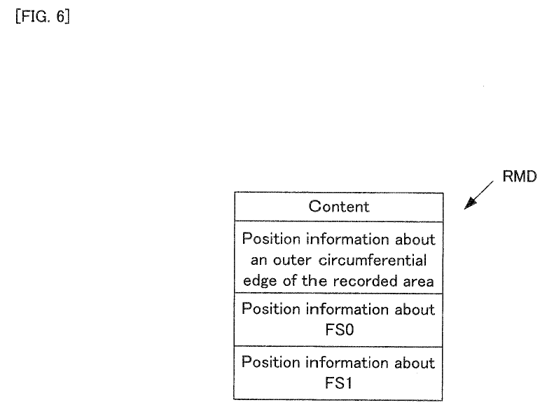

Next, with reference to FIG. 4 to FIG. 6, an explanation will be given on one specific example of a method of recording format data, and the management information. FIG. 4 is a conceptual schematic diagram showing a recording area in which the format data is recorded on the dual-layer rewritable type optical disc in the embodiment of the information recording medium of the present invention. FIG. 5 is a conceptual schematic diagram showing a recording area in which format data is recorded and in which a recording process is performed on the basis of a LJR mode, on the dual-layer rewritable type optical disc in the embodiment of the information recording medium of the present invention. FIG. 6 is a table showing one specific example of the content of RMD associated with management information of the present invention.

According to the embodiment, as shown in FIG. 4, format data (buffer data: zero and Null) for a format process in a recording area is recorded in at least a recording area FS0, from among the recording area FS0 and a recording area FS1 facing the recording area FS0, by an information recording apparatus, wherein reproduction control information, such as a file system, is expected to be recorded into the recording areas FS0 and FS1. In particular, one specific example of the “predetermined record information” of the present invention is constructed by the format data. Moreover, the format data may be recorded in predetermined timing, such as in the manufacturing of the optical disc and in the background format in parallel with the recording operation. Incidentally, the operation and effect of the embodiment will be discussed in detail in “(3) Study of Operation and Effect of Embodiment” described later.

In addition, as shown in FIG. 5, in the recording area in which the format data is recorded on the dual-layer rewritable type optical disc in the embodiment, the recording process based on the LJR mode is performed. Moreover, on the dual-layer rewritable type optical disc in the embodiment, RMD (Recording Management Data) is recorded in the aforementioned recording management area RMA0 (RMA1) by the information recording apparatus, wherein the RMD includes one position information about a position on an outer circumferential edge of the recording area in which the record information is recorded. Specifically, as shown in FIG. 6, the management information in the embodiment may include: (i) one position information about the position on the outer circumferential edge of the recording area in which the record information is recorded, such as an address in the L0 layer; (ii) position information which can specify a position in the recording area FS0; and (iii) position information which can specify a position in the recording area FS1 facing the recording area FS0.

As a result, it is possible to perform the recording process based on a ROW mode, on the recording area in which the record information is recorded on the dual-layer rewritable type optical disc in the embodiment. That is, random write can be performed, including additional recording and rewritable recording, by the information recording apparatus with respect to the dual-layer rewritable type optical disc in the embodiment.

### (2) Embodiment of Information Recording Apparatus

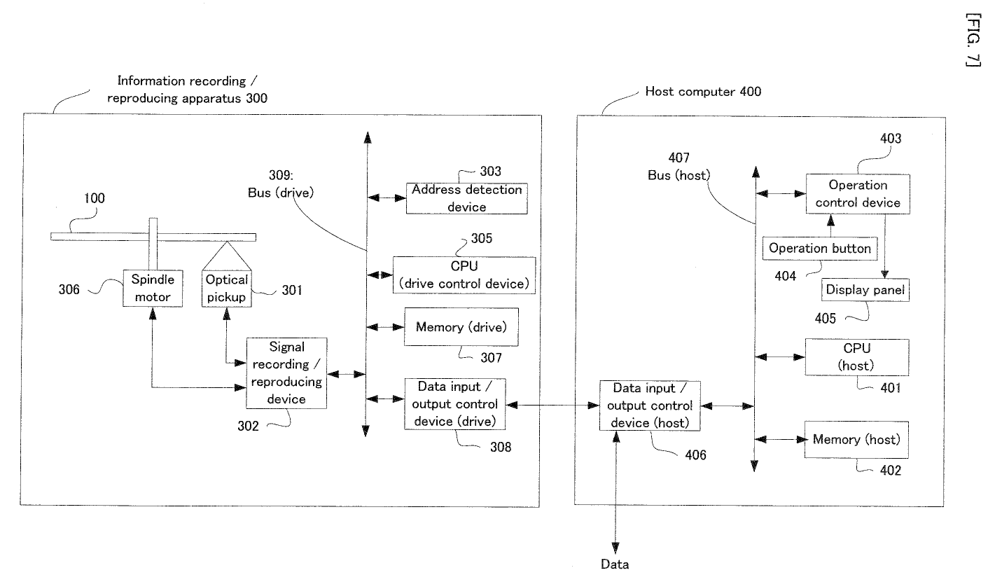

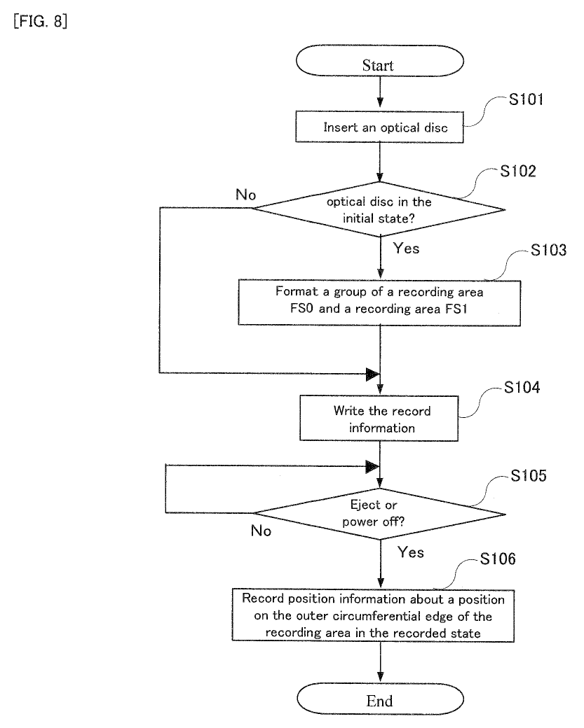

Next, with reference to FIG. 7 and FIG. 8, the structure and the operation of the information recording apparatus in the embodiment of the present invention will be explained in detail. In particular, in the embodiment, the information recording apparatus of the present invention is applied to an information recording/reproducing apparatus for an optical disc.

Firstly, with reference to FIG. 7, the basic structure of an information/reproducing apparatus 300 in the embodiment of the information recording apparatus of the present invention, and a host computer 400 will be discussed. FIG. 7 is a block diagram showing the basic structures of the host computer and the information recording/reproducing apparatus in the embodiment of the information recording apparatus of the present invention. Incidentally, the information recording/reproducing apparatus 300 has a function of recording the record data onto the optical disc 100 and a function of reproducing the record data recorded on the optical disc 100.

With reference to FIG. 7, the inner structure of information recording/reproducing apparatus 300 will be discussed. The information recording/reproducing apparatus 300 is an apparatus for recording the information onto the optical disc 100 and reading the information recorded on the optical disc 100, under the control of a CPU (Central Processing Unit) 305 for the drive.

The information recording/reproducing apparatus 300 is provided with: the optical disc 100; an optical pickup 301; a signal recording/reproducing device 302; an address detection device 303; an address operation device 304; the CPU (drive control device) 305; a spindle motor 306; a memory 307; a data input/output control device 308; and a bus 309.

The host computer 400 is provided with: a CPU (host control device) 401; a memory 402; an operation control device 403; an operation button 404; a display panel 405; a data input/output control device 406; and a bus 407.

In particular, the information recording/reproducing apparatus 300 may be constructed to communicate with an external network by containing the host computer 400 having a communication device, such as a modem, in the same housing. Alternatively, the CPU (host control device) 401 of the host computer 400 having a communication device, such as an i-link, may directly control the information recording/reproducing apparatus 300 through the data input/output control device 308 and the bus 309, to thereby communicate with the external network.

The optical pickup 301 is to perform the recording/reproduction with respect to the optical disc 100, and is provided with a semiconductor laser device, a lens, and the like. More specifically, the optical pickup 301 irradiates the optical disc 100 with a light beam, such as a laser beam, as reading light with a first power upon reproduction, and as writing light with a second power upon recording, with it modulated.

The signal recording/reproducing device 302 controls the optical pickup 301 and the spindle motor 306, to thereby perform the recording/reproduction with respect to the optical disc 100. More specifically, the signal recording/reproducing device 302 is provided with: a laser diode (LD) driver; a head amplifier; and the like, for example. The laser diode driver (LD driver) drives a not-illustrated semiconductor laser device located in the optical pickup 301. The head amplifier amplifies the output signal of the optical pickup 301, i.e. the reflective light of a light beam, and outputs the amplified signal. More specifically, the signal recording/reproducing device 302 drives the not-illustrated semiconductor laser device located in the optical pickup 301, in order to determine an optimum laser power by the recording and reproduction processes for an OPC (Optimum Power Control) pattern, together with a not-illustrated timing generator or the like, under the CPU 305, upon an OPC process. In particular, the signal recording/reproducing device 302 constitutes one example of the “recording device”, together with the optical pickup 301. Moreover, the signal recording/reproducing device 302 may be able to obtain the RMD recorded in the control data zone CDZ or the recording management area RMA0 (RMA1). Thus, the signal recording/reproducing device 302 may constitute one portion of the “obtaining device” of the present invention.

The address detection device detects an address (or address information) on the optical disc 100 from a reproduction signal including a pre-format address signal or the like, which is outputted by the signal recording/reproducing device 302.

The CPU (drive control device) 305 controls the entire information recording/reproducing apparatus 300 by giving an instruction to various controlling devices, through the bus 309. Moreover, software or firmware for operating the CPU 305 is stored in the memory 307. In particular, the CPU 305 is one specific example of the “recording control device” or the “format control device” of the present invention.

The spindle motor 306 is intended to rotate and stop the optical disc 100, and operates upon accessing the optical disc. More specifically, the spindle motor 306 is constructed to rotate and stop the optical disc 100 at a predetermined speed, under spindle servo from a not-illustrated servo unit or the like.

The memory 307 is used in the general data processing and the OPC process or the like on the information recording/reproducing apparatus 300, including a buffer area for the record/reproduction data, an area used as an intermediate buffer when data is converted into the data that can be used on the signal recording/reproducing device 302, and the like. Moreover, the memory 307 is provided with: a ROM area into which a program for performing an operation as a recording device, i.e. firmware, is stored; a buffer for temporary storage of the record/reproduction data; a RAM area into which a parameter required for the operation of a firmware program or the like is stored; and the like.

The data input/output control device 308 controls the input/output of the data from the exterior with respect to the information recording/reproducing apparatus 300, to thereby perform storage to and export from the data buffer on the memory 307. A drive control command issued from the external host computer 400 (hereinafter referred to as a “host”, as occasion demands) connected to the information recording/reproducing apparatus 300 through an interface, such as a SCSI and an ATAPI, is transmitted to the CPU 305 through the data input/output control device 308. Moreover, the record/reproduction data is also transmitted and received with respect to the host computer 400 through the data input/output control device 308, in the same manner.

The CPU (host control device) 401, the memory 402, the data input/output control device 406, and the bus 407 in the host computer 400 are substantially the same as the corresponding constitutional elements in the information recording/reproducing apparatus 300.

The operation control device 403 receives an operation instruction and performs display with respect to the host computer 400, and transmits an instruction by the operation button 404, such as an instruction to record or reproduce, to the CPU 401. The CPU 401 may transmit a control command to the information recording/reproducing apparatus 300, through the data input/output control device 406, on the basis of instruction information from the operation control device 403, to thereby control the entire information recording/reproducing apparatus 300. In the same manner, the CPU 401 can transmit a command for requesting the information recording/reproducing apparatus 300 to transmit an operational state to the host, with respect to the information recording/reproducing apparatus 300. By this, the operational state of the information recording/reproducing apparatus 300, such as during recording and during reproduction, can be recognized, so that the CPU 401 can output the operational state of the information recording/reproducing apparatus 300 to the display panel 405, such as a fluorescent tube and an LCD, through the operation control device 403.

One specific example used by combining the information recording/reproducing apparatus 300 and the host computer 400, as explained above, is household equipment, such as recorder equipment for recording and reproducing video images. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 402, on the CPU 401. Moreover, in another specific example, the information recording/reproducing apparatus 300 is a disc drive (hereinafter referred to as a “drive”, as occasion demands), and the host computer 400 is a personal computer and a work station. The host computer, such as the personal computer, and the drive are connected through the data input/output control device 308 (406), such as the SCSI and the ATAPI, and application, such as writing software, installed in the host computer controls the disc drive.

(2-2) Overall Operation Principle

Next, with reference to FIG. 8 as occasion demands, the operation principle of the information recording/reproducing apparatus in the embodiment of the information recording apparatus of the present invention will be discussed. FIG. 8 is a flowchart showing a format process by the information recording/reproducing apparatus in the embodiment of the information recording apparatus of the present invention.

As shown in FIG. 8, an optical disc is inserted by e.g. a user (step S101).

Then, it is judged whether or not the optical disc is inserted in an initial state, such as a state in manufacturing and shipment, under the control of the CPU (drive control device) 305 (step S102). Here if the optical disc is inserted in the initial state (the step S102: Yes), the format data (buffer data: zero and Null) for the format process in the recording area is recorded in at least the recording area FS0, from among the recording area FS0 and the recording area FS1 facing the recording area FS0, under the control of the CPU 305 (step S103).

Next, under the control of the CPU 305, the record information is recorded from e.g. a recording start address (step S104).

Next, under the control of the CPU 305, it is judged (i) whether or not the optical disc is ejected, or (ii) whether or not the information recording apparatus is powered off (step S105). Here (i) if the optical disc is ejected, or (ii) if the information recording apparatus is powered off (the step S105: Yes), the RMD is recorded into the RMA under the control of the CPU 305, wherein the RMD includes one position information about the position on the outer circumferential edge in the recording area in which the record information is recorded (step S106).

On the other hand, as a result of the judgment in the step S105, (i) if the optical disc is not ejected, or (ii) if the information recording apparatus is not powered off (the step S105: No), the aforementioned judgment in the step S105 is performed under the control of the CPU 305.

### (3) Study of Operation and Effect of Embodiment

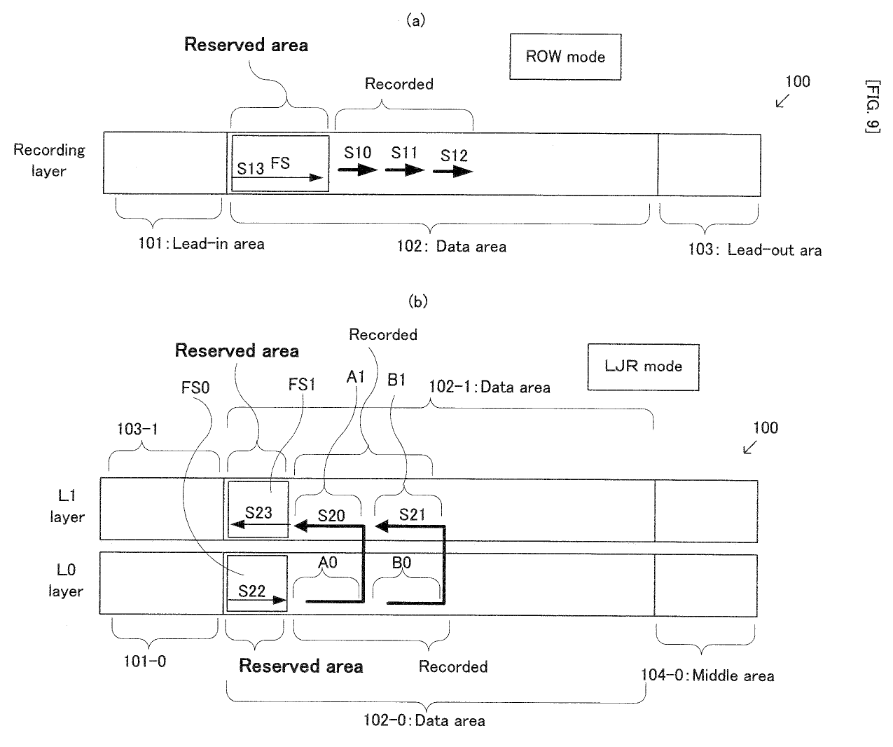

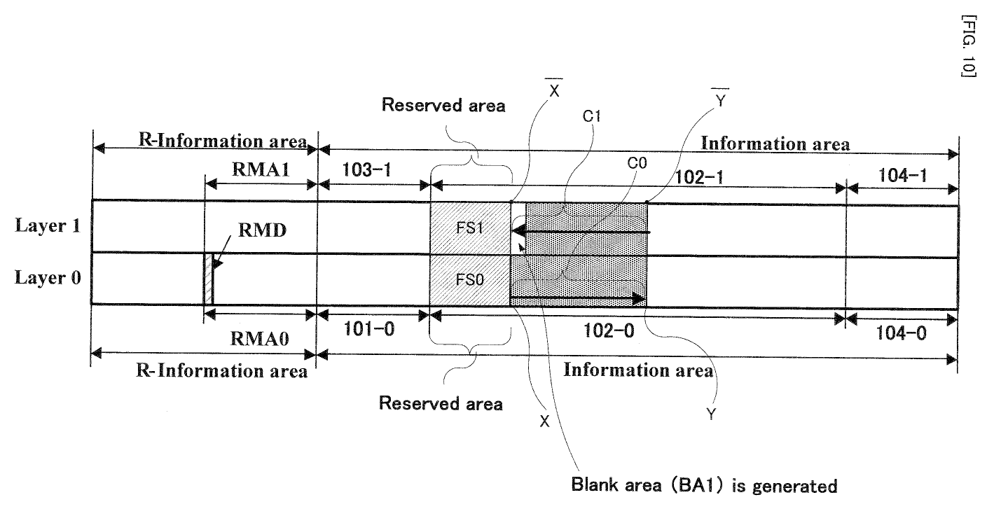

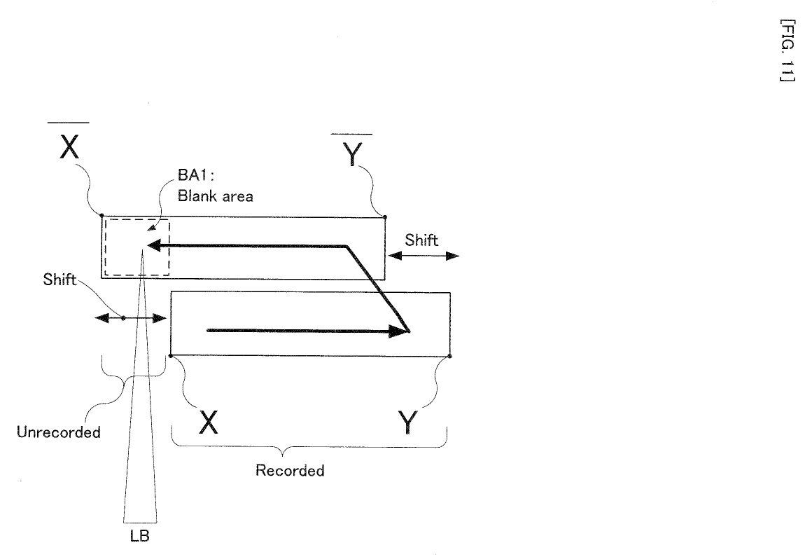

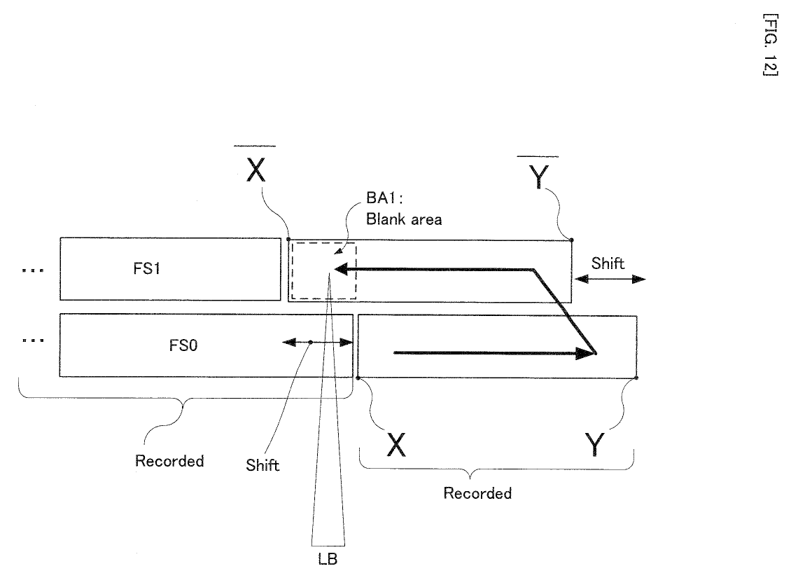

Next, with reference to FIG. 4 as occasion demands in addition to FIG. 9 to FIG. 12, consideration will be given to the operation and effect of the embodiment. FIG. 9 are a conceptual schematic diagram showing a recording process based on a ROW (Restricted Over Write) mode on a single-layer rewritable type optical disc in a comparison example (FIG. 9(a)), and a conceptual schematic diagram showing a recording process based on the LJR (Layer Jump Recording) mode on a dual-layer write-once type optical disc in a comparison example (FIG. 9(b)). FIG. 10 is a conceptual schematic diagram showing a recording process based on the ROW mode and the LJR mode, on a dual-layer rewritable type in a comparison example. FIG. 11 is a schematic diagram enlarging a partial physical structure of a data area in a L1 layer, in which it is hard to record the record information satisfying a recording requirement, on the dual-layer rewritable type in the comparison example. FIG. 12 is a schematic diagram enlarging a partial physical structure of the data area in the L1 layer, in which it is possible to record the record information satisfying a recording requirement, on the dual-layer rewritable type in the embodiment of the information recording medium of the present invention.

As shown in FIG. 9(a), in the ROW mode, generally performed on the single-layer rewritable type information recording medium, the record information is recorded as follows.

Firstly, the record information is recorded from the inner circumference to the outer circumference of the data area 102 in the single recording layer (refer to arrows in steps S10, S11, and S12). In the recording area in which the record information is recorded by above-mentioned recording way, random write can be performed including additional recording (e.g., write-once recording) and rewriting recording.

Lastly, the reproduction control information, such as a file system (i) which can specify the position of the record information and (ii) which can control the reproduction of the record information, is recorded in a predetermined recording area FS that is reserved in advance (refer to an arrow in a step S13).

On the other hand, as shown in FIG. 9(b), in the LJR mode employed on the multilayer write-once type information recording medium, such as a DVD-R DL (Dual Layer), the record information is written once or additionally recorded as follows.

Firstly, the record information is written once by a recording unit of a recording area, including one portion A0 of the data area 102-0 in the L0 layer and one portion A1 of the data area 102-1 in the L1 layer, which is located facing the one portion A0 (refer to a U-shaped arrow in a step S20). Next, the record information is written once by a recording unit of a recording area, including other portion B0 of the data area 102-0 in the L0 layer and other portion B1 of the data area 102-1 in the L1 layer, which is located facing the other portion B0 (refer to a U-shaped arrow in a step S21).

Lastly, the reproduction control information, such as the aforementioned file system, is written once in the predetermined recording area FS0 that is reserved in advance in the L0 layer (refer to an arrow in a step S22). In addition, the reproduction control information, such as a file system, is written once in the predetermined recording area FS1 that is reserved in advance in the L1 layer (refer to an arrow in a step S23).

If both the ROW mode (FIG. 9(a)) and the LJR mode (FIG. 9(b)) are applied on the multilayer rewritable type information recording medium, such as a DVD-RW DL (Dual Layer), the following technical problem occurs.

That is, as shown in FIG. 10, such a technical problem occurs that it is hard to record the record information with the aforementioned recording requirement satisfied, in one portion of the data area in the L1 layer (i.e. a blank area BA1 in the L1 layer) adjacent to a predetermined range of the recording area FS1 (i.e. one specific example of the “second inner area” of the present invention). The predetermined range of the recording area FS1 is located in the inner circumferential portion of the L1 layer while facing a predetermined range of the recording area FS0 (i.e. one specific example of the “first inner area” of the present invention). The predetermined range of the recording area FS0 is located in the inner circumferential portion of the L0 layer and in which the reproduction control information, such as a file system, is expected to be recorded.

Specifically, the aforementioned recording area FS0 and the aforementioned recording area FS1 are reserved so as not to record the record information, such as contents, because the reproduction control information, such as a file system, is expected to be recorded therein. Thus, firstly, the record information is recorded from the inner circumference to the outer circumference in one portion C0 of the data area in the L0 layer adjacent to the aforementioned recording area FS0, on the basis of the aforementioned LJR mode. Then, if the record information is recorded from the outer circumference to the inner circumference in one portion C1 of the data area in the L1 layer adjacent to the aforementioned recording area FS1, the recording area in which the recording process cannot be performed with the recording requirement satisfied, i.e. the blank area BA1, is generated at the boundary of the recording area FS1 and the one portion C1 of the data area in the L1 layer, which is a technical problem.

With regard to the blank area BA1, more specifically, as shown in FIG. 11, there arises a shift at a position in another recording area in the L1 layer (i.e. a recording area expressed by an address “Inv X” to an address “Inv Y”, wherein “Inv” is a function indicating a complement number) corresponding to one recording area in the L0 layer (i.e., a recording area expressed by an address “X” to an address “Y”) because of a process of manufacturing the dual-layer type optical disc. Abovementioned arose shift provides a possibility that the another recording area in the L1 layer is not necessarily irradiated with the laser light LB through the one recording area in the recorded state in the L0 layer. More specifically, it is known that the shift caused by the process of manufacturing the dual-layer type optical disc results from the following causes. That is, (i) in the process of manufacturing the dual-layer type optical disc, such as a DVD-ROM or a DVD-R/RW, a melted polycarbonate resin is molded by using a stampa disc to form the L0 layer and the L1 layer separately, and lastly the substrates of the L0 layer and the L1 layer are bonded. Thus, in the L0 layer and the L1 layer, there is possibly a position shift because of a bonding error. Alternatively, (ii) since the L0 layer and the L1 layer are formed by using different stampas, there is possibly a deviation in a track pitch in each of the recording layers. Alternatively, (iii) if a LPP (Land Pre Pit) is generated separately as a pre-format address in the L0 layer and the L1 layer by a method of laser cutting or the like, there is possibly an address shift caused by a difference in the LPP start position in the L0 layer and the L1 layer.

In contrast, according to the embodiment, as shown in FIG. 4 and FIG. 12 described above, the format data (e.g., buffer data: zero or Null) for the format process in the recording area is recorded in at least the recording area FS0, from among the recording area FS0 and the recording area FS1 facing the recording area FS0, by the information recording apparatus, wherein the reproduction control information, such as a file system, is expected to be recorded into the recording areas FS0 and FS1.

As a result, it is possible to almost or completely eliminate the recording of the record information by the information recording apparatus without the recording requirement satisfied, in one portion of the data area in the L1 layer (e.g., the blank area BA1 in the L1 layer) adjacent to the recording area FS1 (refer to FIG. 12). Consequently, it is possible to record the record information, more appropriately, with the recording requirement satisfied, with respect to all the recording areas including the aforementioned blank area BA1, on the rewritable type information recording medium with a plurality of recording layers, such as a DVD-RW DL.

(Another Specific Example of Method of Recording Format Data)

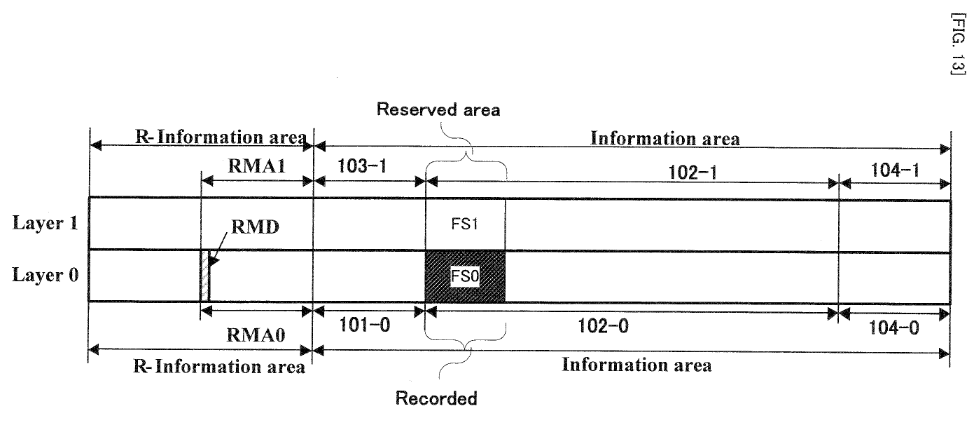

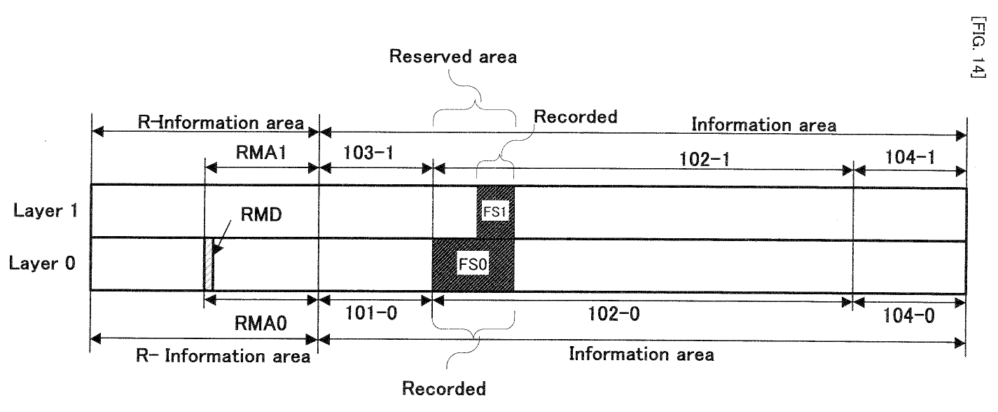

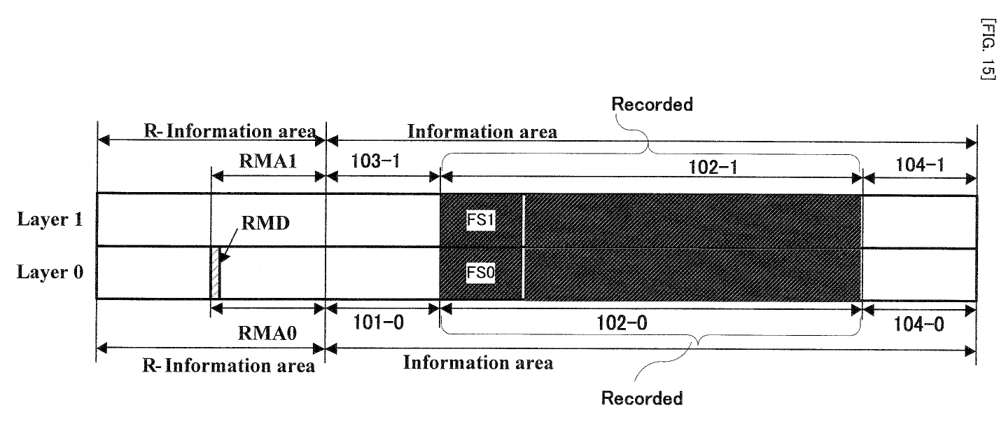

Next, with reference to FIG. 13 to FIG. 15, an explanation will be given on another specific example of the method of recording the format data in the embodiment. FIG. 13 is a conceptual schematic diagram showing another specific example (part 1) of the recording area in which the format data is recorded on the dual-layer rewritable type optical disc in the embodiment of the information recording medium of the present invention. FIG. 14 is a conceptual schematic diagram showing another specific example (part 2) of the recording area in which the format data is recorded on the dual-layer rewritable type optical disc in the embodiment of the information recording medium of the present invention. FIG. 15 is a conceptual schematic diagram showing another specific example (part 3) of the recording area in which the format data is recorded on the dual-layer rewritable type optical disc in the embodiment of the information recording medium of the present invention.

(4-1) Another Specific Example of Method of Recording Format Data

### —Part 1—

According to the embodiment, as shown in FIG. 13, the format data (e.g., buffer data: zero or Null) for the format process in the recording area may be recorded in the recording area FS0, by the information recording apparatus, wherein the reproduction control information, such as a file system, is expected to be recorded into the recording areas FS0.

As a result, it is possible to realize the recording process for the format data, which is recorded in predetermined timing, such as in the manufacturing of the optical disc or in the background format in parallel with the recording operation, more quickly and accurately than the case the recording process is performed in both the recording area FS0 and the recording area FS1.

(4-2) Another Specific Example of Method of Recording Format Data

### —Part 2—

According to the embodiment, as shown in FIG. 14, the format data (e.g., buffer data: zero or Null) for the format process in the recording area may be recorded in (i) the entire recording area of the recording area FS0 and (ii) an outer circumferential edge portion in the recording area FS1 corresponding to one part of the recording area FS0, wherein the reproduction control information, such as a file system, is expected to be recorded into the recording areas FS0 and the outer circumferential edge portion in the recording area FS1.

As a result, it is possible to almost or completely eliminate the recording of the record information by the information recording apparatus without the aforementioned recording requirement satisfied, in one portion of the data area in the L1 layer (e.g., the blank area BA1 in the L1 layer) adjacent to the recording area FS1. And it is possible to realize the recording process for the format data, more quickly and accurately.

(4-3) Another Specific Example of Method of Recording Format Data

### —Part 3—

According to the embodiment, as shown in FIG. 15, the format data (e.g., buffer data: zero and Null) for the format process in the recording area may be recorded in (i) the entire recording area in the L0 layer including the recording area FS0 and (ii) the entire recording area in the L1 layer including the recording area FS1, wherein the reproduction control information, such as a file system, is expected to be recorded into the recording areas FS0 and FS1.

As a result, it is possible to almost or completely eliminate the recording of the record information by the information recording apparatus without the aforementioned recording requirement satisfied, in the entire data area in the L1 layer including one portion of the data area in the L1 layer (e.g., the blank area BA1 in the L1 layer) adjacent to the recording area FS1.

In the aforementioned embodiment, an explanation is given on the dual-layer type optical disc on which the recording or reproduction can be performed by using the laser light, such as blue-ray, red-light LD light, and infrared light, as one specific example of the information recording medium. In addition, the present invention can be also applied to a multilayer type (multiple layer type) optical disc with three or more recording layers, and a single-layer type optical disc. Moreover, the present invention can be also applied to other various information recording media which support high-density recording or high transmission rates.

Furthermore, in the aforementioned embodiment, the information recording/reproducing apparatus for the dual-layer type optical disc is explained as one example of the information recording apparatus. In addition, the present invention can be also applied to an information recording/reproducing apparatus for the multilayer type (multiple layer type) optical disc with three or more recording layers, and the single-layer type optical disc. Moreover, it can be applied to an information recording/reproducing apparatus for the other various information recording media which support high-density recording or high transmission rates.

The present invention is not limited to the aforementioned embodiment, and various changes may be made, if desired, without departing from the essence or spirit of the invention which can be read from the claims and the entire specification. An information recording apparatus and method and a computer program, all of which involve such changes, are also intended to be within the technical scope of the present invention.

### INDUSTRIAL APPLICABILITY

The information recording apparatus and method, the computer program, and the information recording medium according to the present invention can be applied to an information recording medium, such as an optical disc on which the recording and the reproduction can be performed by irradiating it with the laser light, such as a DVD (Digital Versatile Disc), a BD (Blu-ray Disc), and a CD (Compact Disc), and further can be applied to an information recording apparatus for the information recording medium. Moreover, they can be applied to an information recording apparatus or the like which is mounted on various computer equipment for consumer use or for commercial use, or which can be connected to various computer equipment.

1-15. (canceled)

16. An information recording apparatus for performing recording onto an information recording medium comprising: at least (i) a first recording layer in which a first track is formed to record one portion of record information; and (ii) a second recording layer in which a second track is formed to record another portion of the record information, said information recording apparatus comprising:
a recording device for recording the another portion of the record information into at least the second recording layer, by using laser light transmitted through the first recording layer;
a recording control device for controlling said recording device to record the record information by a recording unit of a recording area including a first area in the first recording layer and a second area in the second recording layer located facing the first area; and
a format control device for controlling said recording device to record predetermined record information in at least a first inner area, from among the first inner area located in an inner circumferential portion of the first recording layer and a second inner area facing the first inner area and located in an inner circumferential portion of the second recording layer, reproduction control information for controlling reproduction of the record information being expected to be recorded into the first inner area and the second inner area.

17. The information recording apparatus according to claim 16, wherein said format control device controls said recording device to record the predetermined record information in the first inner area.

18. The information recording apparatus according to claim 16, wherein said format control device controls said recording device to record the predetermined record information in (i) the entire first inner area and (ii) in an outer circumferential edge portion of the second inner area.

19. The information recording apparatus according to claim 16, wherein said format control device controls said recording device to record the predetermined record information in entire recording areas in the first recording layer and the second recording layer.

20. The information recording apparatus according to claim 16, wherein said format control device controls said recording device to record the predetermined record information simultaneously with or in tandem with the recording of the record information.

21. The information recording apparatus according to claim 16, wherein
the information recording medium comprises a management area for recording management information including one position information about an outer circumferential edge portion of the recording area in which the record information is in a recorded state, and
said recording control device controls said recording device to record the management information into the management area.

22. The information recording apparatus according to claim 16, wherein
the information recording medium comprises a management area for (i) managing the recording or reproduction of the record information and (ii) recording management information including another position information about an outer circumferential edge portion in the first inner area and the second inner area, and
said recording control device controls said recording device to record the management information into the management area.

23. The information recording apparatus according to claim 16, wherein
the information recording medium comprises a management area for recording management information including identification information which indicates whether or not the predetermined record information is recorded on the information recording medium, and
said recording control device controls said recording device to record the management information into the management area.

24. The information recording apparatus according to claim 21, wherein
the information recording apparatus further comprises an obtaining device for obtaining the management information,
said format control device controls said recording device to record the predetermined record information on the basis of the obtained management information, and
said recording control device controls said recording device to record the record information on the basis of the obtained management information.

25. An information recording method in an information recording apparatus for performing recording onto an information recording medium comprising: at least (i) a first recording layer in which a first track is formed to record one portion of record information; and (ii) a second recording layer in which a second track corresponding to the first track is formed to record another portion of the record information, said information recording apparatus comprising: a recording device for recording the another portion of the record information into at least the second recording layer, by using laser light transmitted through the first recording layer, said information recording method comprising:
a recording control process of controlling said recording device to record the record information by a recording unit of a recording area including a first area in the first recording layer and a second area in the second recording layer located facing the first area; and
a format control process of controlling said recording device to record predetermined record information in at least a first inner area, from among the first inner area located in an inner circumferential portion of the first recording layer and a second inner area facing the first inner area and located in an inner circumferential portion of the second recording layer, reproduction control information for controlling reproduction of the record information being expected to be recorded into the first inner area and the second inner area.

26. A computer program for recording control and for controlling a computer provided in an information recording apparatus,
said information recording apparatus for performing recording onto an information recording medium comprising: at least (i) a first recording layer in which a first track is formed to record one portion of record information; and (ii) a second recording layer in which a second track is formed to record another portion of the record information, said information recording apparatus comprising:
a recording device for recording the another portion of the record information into at least the second recording layer, by using laser light transmitted through the first recording layer;
a recording control device for controlling said recording device to record the record information by a recording unit of a recording area including a first area in the first recording layer and a second area in the second recording layer located facing the first area; and
a format control device for controlling said recording device to record predetermined record information in at least a first inner area, from among the first inner area located in an inner circumferential portion of the first recording layer and a second inner area facing the first inner area and located in an inner circumferential portion of the second recording layer, reproduction control information for controlling reproduction of the record information being expected to be recorded into the first inner area and the second inner area,
said computer program making the computer function as at least one portion of said recording device, said recording control device, and said format control device.

27. An information recording medium comprising:
at least (i) a first recording layer in which a first track is formed to record one portion of record information; and (ii) a second recording layer in which a second track corresponding to the first track is formed to record another portion of the record information, wherein
predetermined record information is recorded in advance at least in a first inner area, from among the first inner area located in an inner circumferential portion of the first recording layer and a second inner area facing the first inner area and located in an inner circumferential portion of the second recording layer, reproduction control information for controlling reproduction of the record information being expected to be recorded into the first inner area and the second inner area.

28. The information recording medium according to claim 27, comprising a management area for recording management information including one position information about an outer circumferential edge portion of the recording area in which the record information is in a recorded state.

29. The information recording medium according to claim 27, comprising a management area for (i) managing the recording or reproduction of the record information and (ii) recording management information including another position information about an outer circumferential edge portion in the first inner area and the second inner area.

30. The information recording medium according to claim 27, comprising a management area for recording management information including identification information which indicates whether or not the predetermined record information is recorded on the information recording medium.
